(19) United States
(12) Patent Application Publication
(10) Pub. No.: US 2025/0369908 A1
(43) Pub. Date: Dec. 4, 2025

(54) RFID PLATFORM WITH ENVIRONMENTALLY SENSITIVE READ RANGE

(71) Applicant: Temptime Corporation, Morris Plains, NJ (US)

(72) Inventors: Eric W. Liberato, Pequannock, NJ (US); Michael S. Weinhammer, Cary, IL (US); Mohannad Abdo, Clifton, NJ (US); Gene A. Hofer, Lake Zurich, IL (US)

(73) Assignee: Temptime Corporation, Morris Plains, NJ (US)

(21) Appl. No.: 18/679,819

(22) Filed: May 31, 2024

(51) Int. Cl. G01N 27/12; G06K 7/10; G06K 19/077

(52) U.S. Cl. CPC G01N 27/12; G06K 7/10356; G06K 19/07775

(57) ABSTRACT

RFID platforms with environmentally sensitive read ranges are disclosed herein. An example RFID tag includes an integrated circuit, an environmental indicator material that changes between a conductive state and a nonconductive state responsive to a predetermined environmental exposure, and an antenna, having a first antenna portion and a second antenna portion. The first antenna portion is electrically connected in a closed circuit with the integrated circuit, and wherein the second antenna portion is electrically connected in the closed circuit with the first antenna portion and with the integrated circuit when the environmental indicator material is in the conductive state and in an open circuit when the environmental indicator material is in the nonconductive state.

### BACKGROUND

Many commercial products are sensitive to environmental conditions, such as freezing, thawing, high or low temperatures, exposure to chemicals, and/or humidity exposures, and may lose efficacy or quality under any of these conditions. Examples of temperature-sensitive commercial products include certain pharmaceuticals, medical products, and foodstuffs as well as some industrial products. Environmental sensor systems have been used to detect such changes. Some proposed environmental sensor systems change an electrical property of an electrical component in response to predetermined environmental conditions.

Radio Frequency ID tags are often used to track products. Some combinations of Radio Frequency ID Tags with environmental monitors have been developed. The RFID tag generally transmits a stored code when interrogated by a radio signal of an appropriate frequency. Passive RFIDs are powered by the received radio signal.

Proposals for combinations of RFID tags and environmental monitors have been made previously. These combinations generally operate by activating or deactivating the RFID based on the state of the environmental monitor so that it responds or ceases to respond when interrogated, or by changing a value transmitted by the RFID when interrogated based on the state of the environmental monitor.

There is a continued need for improved combinations of RFID tags and environmental monitors for many applications.

### SUMMARY

In a first embodiment, the technology of the present disclosure may be provided by a radiofrequency identification (RFID) tag, including an integrated circuit, an environmental indicator material that changes between a conductive state and a nonconductive state responsive to a predetermined environmental exposure, and an antenna, having a first antenna portion and a second antenna portion. The first antenna portion is electrically connected in a closed circuit with the integrated circuit, and wherein the second antenna portion is electrically connected in the closed circuit with the first antenna portion and with the integrated circuit when the environmental indicator material is in the conductive state and in an open circuit when the environmental indicator material is in the nonconductive state.

In a variation of this embodiment, the RFID tag has a first read range in response to an interrogation signal from an RFID reader having a specified frequency range and a specified power range when the environmental indicator material is in the nonconductive state and a second read range in response to the interrogation signal from the RFID reader having the specified frequency range and the specified power range when the environmental indicator material is in the conductive state, the second read range being greater than the first read range.

In a variation of this embodiment, the RFID tag is unresponsive to the interrogation signal from the RFID reader when the RFID reader is spaced away from the RFID tag by a distance that is greater than the first read range and less than the second read range and the environmental indicator material is in the nonconductive state and is responsive to the interrogation signal from the RFID reader to output a response signal when the RFID reader is spaced away from the RFID tag by a distance that is greater than the first read range and less than the second read range and the environmental indicator material is in the conductive state.

In a variation of this embodiment, when the RFID tag is unresponsive to the interrogation signal, a lack of the response signal is indicative that the predetermined environmental exposure has not occurred and when the RFID tag is responsive to output the response signal to the interrogation signal from the RFID reader, the output of the response signal is indicative of an occurrence of the predetermined environmental exposure.

In a variation of this embodiment, the integrated circuit is configured, responsive to the RFID tag being interrogated by an interrogation signal in a predetermined radiofrequency range which is received by the antenna, to cause the antenna to emit a first distinct radiofrequency response when the second antenna portion is in the closed circuit, and a second distinct radiofrequency response when the second antenna portion is in the open circuit.

In a variation of this embodiment, a distance at which the first distinct radiofrequency response can be detected by an interrogating device is greater than a distance at which the second distinct radiofrequency response can be detected by the interrogating device.

In a variation of this embodiment, the first distinct radiofrequency response and second distinct radiofrequency response are emitted on different frequencies.

In a variation of this embodiment, the integrated circuit comprises a memory storing a data, and the first distinct radiofrequency response and the second distinct radiofrequency response transmit the data.

In a variation of this embodiment, the environmental indicator material is connectively disposed between the first antenna portion and the second antenna portion, such that a length of the antenna that is connected in a closed circuit with the integrated circuit corresponds to whether the environmental indicator material is conductive state or nonconductive state.

In a variation of this embodiment, the environmental indicator material transitions from the nonconductive state to the conductive state responsive to the predetermined environmental exposure.

In a variation of this embodiment, the environmental indicator material transitions from the conductive state to the nonconductive state responsive to the predetermined environmental exposure.

In a variation of this embodiment, the environmental indicator material reverts to the nonconductive state responsive to a conclusion of the predetermined environmental exposure.

In a variation of this embodiment, the environmental indicator material remains in the conductive state permanently, when no longer exposed to the predetermined environmental exposure.

In a variation of this embodiment, the RFID tag is a passive RFID tag, and the interrogation signal received by the antenna powers the integrated circuit to cause the antenna to emit a radiofrequency response.

In a variation of this embodiment, the RFID tag further includes a battery. The integrated circuit is electrically connected to the battery and powered by the battery.

In a variation of this embodiment, the predetermined environmental exposure is selected from a group consisting of: a temperature excursion above a predetermined temperature, a temperature excursion above a predetermined temperature threshold for at least a predetermined amount of time, a temperature excursion below a predetermined temperature, a temperature excursion below a predetermined temperature for at least a predetermined amount of time, cumulative exposure to temperature over a time period above a predetermined threshold for at least a predetermined amount of time, an exposure to a particular chemical, an oxygen exposure, an amount of time, an exposure to at least a predetermined amount of radiation of a particular type, an predetermined electromagnetic exposure, a humidity exposure, an exposure to a humidity level above a predetermined threshold, and an exposure to a humidity level above a predetermined threshold for at least a predetermined amount of time.

In a variation of this embodiment, the environmental indicator material includes conductive particles suspended in a solid matrix. The predetermined environmental exposure disengages the solid matrix such that the conductive particles contact one another and transition the environmental indicator material to the conductive state.

In a variation of this embodiment, the matrix comprises a material selected from a group consisting of of a polymer having side-chain crystallinity, an alkane, a wax, an alkane wax, and combinations thereof.

In a variation of this embodiment, the predetermined environmental exposure is an exposure to electromagnetic radiation above a predetermined threshold, and the environmental indicator material includes a substance that cures responsive to the electromagnetic radiation, and is electrically conductive when cured, such that when exposed to the electromagnetic radiation above the predetermined threshold, the substance cures and transitions to the conductive state.

In a variation of this embodiment, the predetermined environmental exposure is an exposure to a predetermined humidity level, and the environmental indicator material includes a hydratable substance that is electrically conductive when hydrated, such that an exposure to the predetermined humidity level is sufficient to hydrate the hydratable substance and transition the environmental indicator material to the conductive state.

In a second embodiment, the technology of the present disclosure may be provided by a radiofrequency identification (RFID) tag, including an integrated circuit, a plurality of environmental indicator materials that each change between a conductive state and a nonconductive state responsive to respective predetermined environmental exposures, and an antenna having a plurality of antenna portions. A first antenna portion of the plurality of antenna portions is electrically connected in a closed circuit with the integrated circuit. A second antenna portion of the plurality of antenna portions is electrically connected in a closed circuit with the first antenna portion and the integrated circuit when a first of the environmental indicator materials is in the conductive state, and in an open circuit with the integrated circuit and the first antenna portion when the first of the environmental indicator materials is in the nonconductive state. A third antenna portion of the plurality of antenna portions is electrically connected in a closed circuit with the second antenna portion, the first antenna portion, and the integrated circuit when a second of the environmental indicator materials and the first of the environmental indicator materials are both in the conductive state, and in the open circuit with the integrated circuit and the first antenna portion when at least one of the first of the environmental indicator materials and the second of the environmental indicator materials is in the nonconductive state.

In a variation of this embodiment, the RFID tag has a first read range in response to an interrogation signal from an RFID reader having a specified frequency range and a specified power range when the first of the environmental indicator materials is in the nonconductive state and a second read range in response to the interrogation signal from the RFID reader having the specified frequency range and the specified power range when the first of the environmental indicator materials is in the conductive state, the second read range being greater than the first read range.

In a variation of this embodiment, the RFID tag has a third read range in response to an interrogation signal from an RFID reader having a specified frequency range and a specified power range when the first of the environmental indicator materials is in the conductive state and the second of the environmental indicator materials is in the conductive state, the third read range being greater than the second read range.

In a variation of this embodiment, the RFID tag is unresponsive to the interrogation signal from the RFID reader when the RFID reader is spaced away from the RFID tag by a distance that is greater than the first read range and less than the second read range and the first of the environmental indicator materials is in the nonconductive state and is responsive to the interrogation signal from the RFID reader to output a response signal when the RFID reader is spaced away from the RFID tag by a distance that is greater than the first read range and less than the second read range and the first of the environmental indicator materials is in the conductive state.

In a variation of this embodiment, when the RFID tag is unresponsive to the interrogation signal, a lack of the response signal is indicative that the predetermined environmental exposure has not occurred and when the RFID tag is responsive to output the response signal to the interrogation signal from the RFID reader, the output of the response signal is indicative of an occurrence of the predetermined environmental exposure.

In a variation of this embodiment, the RFID tag is configured, responsive to the RFID tag being interrogated by an interrogation signal in a predetermined radiofrequency range which is received by the antenna, to cause the antenna to emit a first distinct radiofrequency response when the second antenna portion and the third antenna portion are in the open circuit, cause the antenna to emit a second distinct radiofrequency response when the second antenna portion is in the closed circuit and the third antenna portion is in the open circuit, and cause the antenna to emit a third distinct radiofrequency response when the second antenna portion and the third antenna portion are in the closed circuit.

In a variation of this embodiment, the third distinct radiofrequency response has a lower frequency than the second distinct radiofrequency response, and the second distinct radiofrequency response has a lower frequency than the first distinct radiofrequency response.

In a variation of this embodiment, a distance at which the third distinct radiofrequency response can be detected by an interrogating device is greater than a distance at which the second distinct radiofrequency response can be detected by the interrogating device, and the second distinct radiofrequency response can be detected by an interrogating device is greater than a distance at which the first distinct radiofrequency response can be detected by the interrogating device.

In a variation of this embodiment, the integrated circuit comprises a memory, and the first distinct radiofrequency response and the second distinct radiofrequency response contain a data stored in the memory.

In a variation of this embodiment, the integrated circuit comprises a memory, and the first distinct radiofrequency response contains a first data stored in the memory, and the second distinct radiofrequency response contains a second data stored in the memory.

In a variation of this embodiment, the first of the environmental indicator materials is connectively disposed between the first antenna portion and the second antenna portion, and the second of the environmental indicator materials is connectively disposed between the second antenna portion and the third antenna portion.

In a variation of this embodiment, the environmental indicator material transitions from the conductive state to the nonconductive state responsive to the predetermined environmental exposure.

In a variation of this embodiment, the environmental indicator material transitions from the conductive state to the nonconductive state responsive to, and during, an exposure to the predetermined environmental exposure, and subsequently reverts to the conductive state when no longer exposed to the predetermined environmental exposure.

In a variation of this embodiment, the environmental indicator material transitions from the nonconductive state to the conductive state responsive to, and during, an exposure to the predetermined environmental exposure, and subsequently reverts to the nonconductive state when no longer exposed to the predetermined environmental exposure.

In a variation of this embodiment, the first of the environmental indicator materials changes between a conductive state and a nonconductive state responsive to a first threshold of the predetermined environmental exposure, and the second of the environmental indicator materials changes between the conductive state and the nonconductive state responsive to a second threshold of the predetermined environmental exposure, distinct from the first threshold.

In a variation of this embodiment, the first of the environmental indicator materials changes between a conductive state and a nonconductive state responsive to a first predetermined environmental exposure, and the second of the environmental indicator materials changes between the conductive state and the nonconductive state responsive to a second predetermined environmental exposure, distinct from the first predetermined environmental exposure.

In a variation of this embodiment, the RFID tag is a passive RFID tag, and a radiofrequency signal received by the antenna powers the integrated circuit to cause the antenna to emit a radiofrequency response.

In a variation of this embodiment, the RFID tag further includes a battery. The integrated circuit is electrically connected to the battery and powered by the battery.

In a variation of this embodiment, the predetermined environmental exposure is selected from a group consisting of: a temperature excursion above a predetermined temperature, a temperature excursion above a predetermined temperature threshold for at least a predetermined amount of time, a temperature excursion below a predetermined temperature, a temperature excursion below a predetermined temperature for at least a predetermined amount of time, cumulative exposure to temperature over a time period above a predetermined threshold for at least a predetermined amount of time, an exposure to a particular chemical, an oxygen exposure, an amount of time, an exposure to at least a predetermined amount of radiation of a particular type, an predetermined electromagnetic exposure, a humidity exposure, an exposure to a humidity level above a predetermined threshold, and an exposure to a humidity level above a predetermined threshold for at least a predetermined amount of time.

In a variation of this embodiment, the environmental indicator material includes conductive particles suspended in a matrix. The predetermined environmental exposure disengages the matrix such that the conductive particles contact one another and transition the environmental indicator material to the conductive state.

In a variation of this embodiment, the matrix comprises a material selected from a group consisting of a polymer having side-chain crystallinity, an alkane, a wax, an alkane wax, and combinations thereof.

In a variation of this embodiment, the predetermined environmental exposure is an exposure to electromagnetic radiation above a predetermined threshold, and the environmental indicator material includes a substance that cures responsive to the electromagnetic radiation, and is electrically conductive when cured, such that when exposed to the electromagnetic radiation above the predetermined threshold, the substance cures and transitions to the conductive state.

In a variation of this embodiment, the predetermined environmental exposure is an exposure to a predetermined humidity level, and the environmental indicator material includes a hydratable substance that is electrically conductive when hydrated, such that exposure to the predetermined humidity level is sufficient to hydrate the hydratable substance and transition the environmental indicator material to the conductive state.

In a variation of this embodiment, a fourth antenna portion is in the closed circuit with the third antenna portion, the second antenna portion, the first antenna portion, and the integrated circuit when a third of the environmental indicator materials, the second of the environmental indicator materials and the first of the environmental indicator materials are in the conductive state, and in the open circuit when at least one of the third of the environmental indicator materials, the second of the environmental indicator materials and the first of the environmental indicator materials are in the open circuit.

In a third embodiment, the technology of the present disclosure may be provided by a system, including an interrogation device, configured to emit an interrogation signal in a predetermined radiofrequency range, a host product, having an environmental sensitivity, and an RFID tag, disposed proximately to the host product, including an integrated circuit, an environmental indicator material that changes between a conductive state and a nonconductive state responsive to a predetermined environmental exposure, and an antenna, having a first antenna portion and a second antenna portion. The first antenna portion is electrically connected in a closed circuit with the integrated circuit. The second antenna portion is electrically connected in the closed circuit with the first antenna portion and with the integrated circuit when the environmental indicator material is in the conductive state and in an open circuit when the environmental indicator material is in the nonconductive state. A response behavior of the RFID tag responsive to the interrogation signal of the interrogation device, which is received by the antenna, changes corresponding to whether the environmental indicator material is in the conductive state or the nonconductive state to indicate whether the host product has been exposed to the predetermined exposure corresponding to the environmental sensitivity of the host product.

In a variation of this embodiment, the integrated circuit is configured to cause the antenna to emit a first distinct radiofrequency response when the second antenna portion is in the closed circuit, and a second distinct radiofrequency response when the second antenna portion is in the open circuit.

In a variation of this embodiment, the predetermined environmental exposure corresponds to the environmental sensitivity, such that the second distinct radiofrequency response indicates that the host product has been exposed to the predetermined environmental exposure corresponding to the environmental sensitivity of the host product.

In a variation of this embodiment, the first distinct radiofrequency response is detectable within a first range by the interrogation device, and the second distinct radiofrequency response is detectable within a second range by the interrogation device, the second range being larger than the first range.

In a variation of this embodiment, the second range has a radius at least 1 meter (m) greater than the first range.

In a variation of this embodiment, the second range has a radius between 1 m and 25 m.

In a variation of this embodiment, where the system further includes a plurality of host products, each having a respective RFID tag. The interrogation device is disposed beyond the first range of each RFID tag and within the second range of each RFID tag, such that when a given host product is exposed to the predetermined environmental exposure, the environmental indicator material of the respective RFID tag transitions to the conductive state and the respective RFID tag has the second distinct radiofrequency response having the second range, and the respective RFID tag is detectable by the interrogation device.

In a variation of this embodiment, the environmental sensitivity is a thermal sensitivity, and the predetermined environmental exposure is a high temperature excursion, such that when the host product is exposed to a temperature above a predetermined threshold the RFID tag emits the second distinct radiofrequency response when interrogated, indicating that the host product and the RFID tag have been exposed to the temperature above the predetermined threshold.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed technology and explain various principles and advantages of those embodiments.

FIG. 1 illustrates an RFID tag with environmentally sensitive read range, where an environmental indicator material in the tag is in a nonconductive state, according to embodiments of the present disclosure.

FIG. 2 illustrates a detailed view of the environmental monitor in a nonconductive state, according to embodiments of the present disclosure.

FIG. 3 illustrates the RFID tag with environmentally sensitive read range, where the environmental indicator material in the tag is in a conductive state, according to embodiments of the present disclosure.

FIG. 4 illustrates a detailed view of the environmental monitor in a conductive state, according to embodiments of the present disclosure.

FIGS. 5A-5D illustrate various states of an RFID tag with progressive environmental read range, according to embodiments of the present disclosure.

FIG. 6 illustrates an RFID reader and RFID tags, according to embodiments of the present disclosure.

FIG. 7 illustrates an environmentally sensitive RFID tag detection system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Described herein are radiofrequency identification (RFID) tags having an environmentally sensitive read range(s).

Certain products and items of manufacture have environmental sensitivities which can result in degradation, contamination, or spoilage of the product. Non-limiting example of such products are vaccines, insulin, other medications, fruits, vegetables, dairy products, meat products, other foodstuffs, dry goods, and the like.

Warm temperatures and other environmental exposures can also affect the quality of environmentally sensitive host product adversely. To help mitigate problems associated with undesirable temperature conditions, a sensor system can be associated with the host product that is thermally sensitive, to provide an indication to an end-user, that the host product may have been thermally affected and possibly should not be used.

Use of RFID tags can permit efficient retrieval of information regarding an item at various points in the manufacturing and distribution chain and can also permit tracking of the individual item. Some RFID tags permit relatively large amounts of data to be associated with the product. An RFID tag may include a memory, an RF transmitter, an RF receiver, an antenna, and logic for controlling the various components of the memory device. The antenna may be formed on a flexible substrate, while analog RF transmitter and receiver and digital logic and memory circuits may be discrete components or included together in an integrated circuit carried by the substrate and coupled to the antenna. The integrated circuit may store and process information, modulate and demodulate RF signals, and perform other specialized functions. RFID tags may also include a number of discrete electronic components, such as capacitors, transistors, and diodes.

RFID tags can be either passive or active devices. Active devices are self-powered, typically by a battery. Passive devices, which are often cheaper and have no issues with battery life, lack their own power source and derive energy from the RF signal used to interrogate the RFID tag. Passive RFID tags usually include an analog circuit, which detects and decodes the interrogating RF signal, and which provides power from the RF field to a digital circuit in the tag. The digital circuit generally executes all of the functions performed by the RFID tag, such as retrieving stored data from memory and modulating the RF signal to transmit the retrieved data. In addition to retrieving and transmitting data previously stored in the memory, the RFID tag can permit new or additional information to be stored into the RFID tag's memory or can permit the RF tag to manipulate data or perform some additional functions.

The read range of an RFID tag is the distance at which the RFID tag can be detected by an RFID reader, and, for a particular type of reader or required power letter, often corresponds to the size of an antenna on the RFID tag, e.g., a larger antenna may provide an increased read range to the RFID tag. The size of RFID tag antenna is often fixed the time of at manufacture; however, the present disclosure introduces an approach for varying antenna length responsive to environmental stimuli by employing materials having conductivity dependent on environmental conditions. As an example, such an RFID tag may include an antenna having two or more antenna portions, the antenna portions connected by the materials having conductivity dependent on environmental conditions. The material may be configured to change from a nonconductive state to a conductive state, or vice versa, responsive to a predetermined environmental exposure. When the material transitions from a nonconductive state to a conductive state, the material facilitating electrical connection between the antenna portions, thus increasing the length of the antenna, thus increasing the read range of the RFID tag. Similarly, a system that transition from conductive to nonconductive responsive to environmental stimuli might shorten the antenna, reducing the read range. In this manner, the RFID tag may be employed as an indicator system, whereby an RFID reader may be configured to detect RFID tags with the extended range (e.g., the material is in the conductive state) and configured such that RFID tags without the extended range (e.g., the material is in the nonconductive state) are undetectable or otherwise ignored by the reader, such that RFID tags having been exposed to the predetermined environmental exposure can be readily identified.

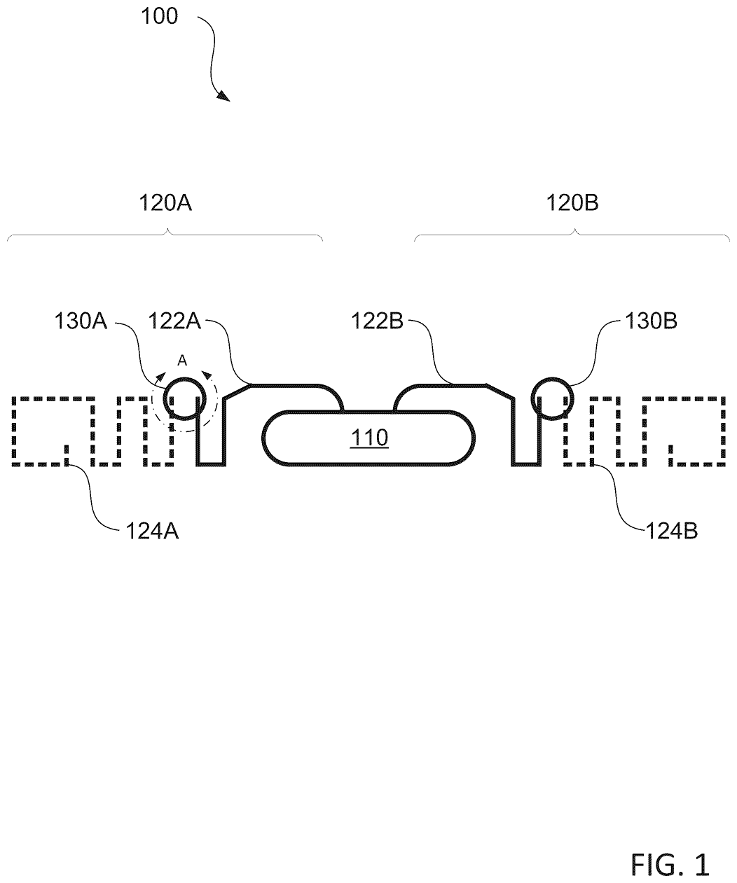

FIGS. 1-4 illustrate an RFID tag 100 and components thereof, where the RFID tag has a restricted antenna state and an extended antenna state. When interrogated, the restricted antenna state may indicate that the RFID tag 100 has not been exposed to a predetermined environmental exposure, and the extended antenna state may indicate that the RFID tag 100 has been exposed to the predetermined environmental exposure.

FIG. 1 illustrates an RFID tag 100 in a restricted antenna state, according to embodiments of the present disclosure. The RFID tag 100 includes an integrated circuit 110, an antenna including a first antenna portion 122 and a second antenna portion 124 physically joined to the first antenna portion by an environmental indicator material 130 having a conductive state and a nonconductive state.

Note that the antenna components (first antenna portion 122, second antenna portion 124) of the RFID tags depicted in the Figures are often illustrated as mirrored, such that each RFID tag has identical antenna components on respective opposite sides of the integrated circuit 110. In some instances, a distinction between a first side antenna component and a second side antenna component may be made with A-B identifiers for clarity, and in other instances such components may be referred to collectively or generally without the use of an A-B identifier. Unless otherwise stated, a first side antenna component (e.g. first antenna portion 122A) and a second side antenna component (e.g. first antenna portion 122B) may be regarded as identical.

The first antenna portion 122 is electrically connected to the integrated circuit 110 (e.g., the integrated circuit 110 and the first antenna portion 122 are in a closed circuit). As used herein, the term “electrically connected” (and variations across parts of speech) may mean that the referenced elements are directly or indirectly connected in such a way as to allow electric current to flow between the referenced components.

The first antenna portion 122 is physically joined to the second antenna portion 124 via the environmental indicator material 130. The environmental indicator material 130 has a conductive state and a nonconductive state, where the environmental indicator material 130 may change from the nonconductive state to the conductive state responsive to an environmental exposure (e.g., predetermined environmental stimulus, predetermined environmental exposure). When the environmental indicator material 130 is in the nonconductive state, the second antenna portion 124 is not electrically connected to (electrically isolated from) the first antenna portion 122. When the environmental indicator material 130 is in the conductive state, the second antenna portion 124 is electrically connected to the first antenna portion 122 and the integrated circuit (e.g., the second antenna portion 124 is in the closed circuit with the integrated circuit 110 and the first antenna portion 122). The functional length of the antenna 120 is approximately the total length of the antenna portions that are electrically connected to the integrated circuit 110. Thus, when the environmental indicator material 130 is in the nonconductive state, the second antenna portion 124 is not electrically connected to the integrated circuit, and the functional length of the antenna 120 is approximately the length of the first antenna portion 122, and the RFID tag 100 is considered to be in the restricted antenna state.

Said differently, when the environmental indicator material 130 is in the nonconductive state, the environmental indicator material 130 does not facilitate an electrical connection between the first antenna portion 122 and the second antenna portion 124. When in the nonconductive state, the environmental indicator material 130 may provide resistance, insulation, or impedance to a flow of electricity, such that two or more elements connected by the environmental indicator material 130 are not electrically connected. While the environmental indicator material 130 may have certain conductive properties in the nonconductive state, it is understood that the conductivity of the environmental indicator material 130 in the nonconductive state is insufficient to facilitate an electrical connection of operable condition between the first antenna portion 122 and the second antenna portion 124.

In some examples, the RFID tag 100 is a passive tag, such that the RF signals received by the antenna 120 may provide power to the RFID tag 100, such that the antenna 120 may transmit an RF signal in response. In other embodiments, the integrated circuit may include an electrical connection to a battery, or other power source capable of powering the RFID tag 100 to transmit an RF signal without having first received an interrogative RF signal. The integrated circuit 110 may contain a variety of circuitry components, which may include a memory in which data is stored, such that the RFID tag 100 is capable of transmitting the data contained in the memory to an RFID reader.

When the RFID tag 100 in the restricted antenna state is interrogated by an interrogating device having a specified frequency and power range, the RFID tag 100 engages in a predetermined restricted antenna response behavior, corresponding to the restricted antenna state. In some examples, the predetermined restricted antenna response behavior is to output a response signal, having a predetermined frequency, read range, and/or data content. In some examples, the predetermined restricted antenna response behavior is a non-response (e.g. the RFID tag 100 is unresponsive and does not emit a response signal). For example, the RFID tag may not be capable of harvesting a sufficient amount of energy from the interrogation signal of the interrogation device, and therefore, may be unable to provide sufficient power to allow the logic circuit to operate and respond to the interrogation signal (e.g., because the interrogation device is outside of the read range of the RFID tag).

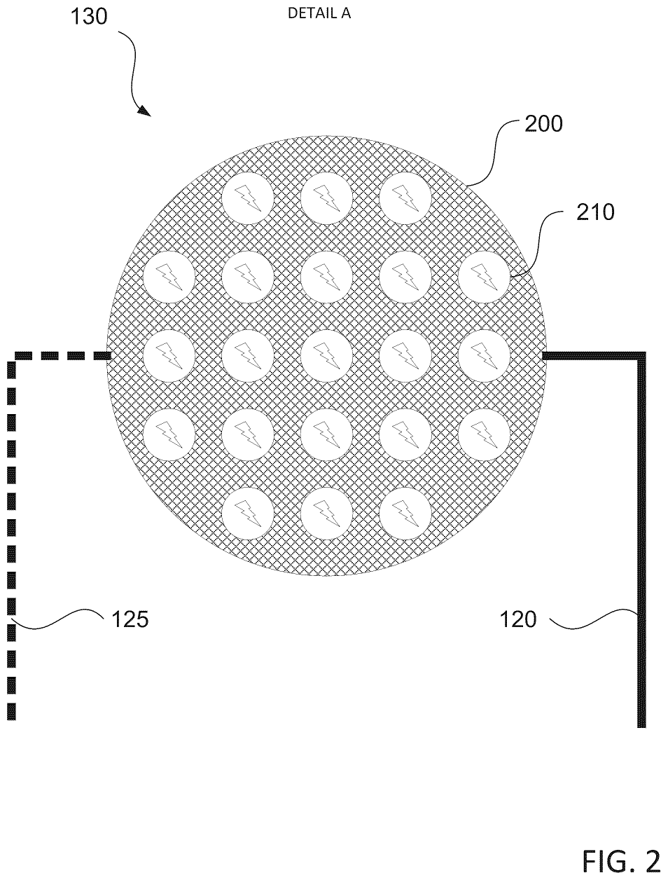

FIG. 2 illustrates Detail A of FIG. 1, in which the environmental indicator material 130 in the nonconductive state is depicted, according to embodiments of the present disclosure.

According to some embodiments, the environmental indicator material 130 may be configured to transition between the nonconductive state and the conductive state responsive to a temperature excursion above a predetermined temperature, a temperature excursion above a predetermined temperature threshold for at least a predetermined amount of time, a temperature excursion below a predetermined temperature, a temperature excursion below a predetermined temperature for at least a predetermined amount of time, cumulative exposure to temperature over a time period above a predetermined threshold for at least 15redatermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, an predetermined electromagnetic exposure, a humidity exposure, an exposure to a humidity level above a predetermined threshold, an exposure to a humidity level above a predetermined threshold for at least a predetermined amount of time, and the like.

According to some embodiments, the environmental indicator material 130 may be a material containing several substances, components, or supplementary materials. Example environmental indicator materials 130 may be referred to generally or collectively as “the environmental indicator material 130” irrespective of the number of supplemental substances, components or materials used to form the environmental indicator material 130.

In the illustrated embodiment, a first example environmental indicator material 130 includes a carrier material 200, and a plurality of conductive particles 210. In the nonconductive state, the carrier material is in a solid phase. As used herein, the term “solid phase” may refer to a material in a non-liquid state such that the material is incapable of fluid flow. In some examples “solid phase” may refer to a gelled state, a highly viscous state, a true solid state, and the like. As used herein, the term “liquid phase” is used to describe a state of a material in which the material is capable of fluid flow.

According to some embodiments, the carrier material 200 may be any such material capable of exhibiting a phase change (e.g. liquefying) from a substantially solid phase to a liquid phase upon the occurrence of a predetermined environmental stimulus (e.g., predetermined environmental exposure).

In one embodiment, the carrier material 200 is a meltable solid configured to melt in response to a predetermined temperature above a threshold, forming a liquid. In another embodiment, the carrier material 200 is a gel configured to, in response to a predetermined environmental exposure above a predetermined threshold, change viscosity such that the gel is substantially liquidized. For example, the material may be a side-chain crystallizable polymer combined with an alkane wax. Some side-chain crystallizable (SCC) polymers useful in the practice of the present disclosure, alone or in combination, and methods that can be employed for preparing them, are described in O'Leary et al. “Copolymers of poly(n-alkyl acrylates): synthesis, characterization, and monomer reactivity ratios” in Polymer 2004 45 U.S. Plant Pat. No. 6,575-6585 (“O'Leary et al.” herein), and in Greenberg et al. “Side Chain Crystallization of n-Alkyl Polymethacrylates and Polyacrylates” J. Am. Chem. Soc., 1954, 76(24), pp. 6280-6285 (“Greenberg et al.” herein). The disclosure of each of O'Leary et al. and Greenberg et al. is incorporated by reference herein for all purposes.

Side-chain crystallizable polymers, sometimes called “comb-like” polymers, are well-known and available commercially. These polymers are reviewed in J. Polymer Sci. Macromol. Rev. 8:117-253 (1974), the disclosure of which is hereby incorporated by reference. In general, these polymers contain monomer units X of the formula:

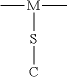

where M is a backbone atom, S is a spacer unit and C is a crystallizable group. These polymers have a heat of fusion (ΔH_{f}) of at least about 20 Joules/g, preferably at least about 40 Joules/g. The polymers will contain about 50 to 100 percent monomer units represented by “X”. If the polymer contains less than 100 percent X, it will in addition contain monomer units which may be represented by “Y” or “Z”, or both, wherein Y is any polar or nonpolar monomer or mixture of polar or nonpolar monomers capable of polymerizing with X and/or Z, and wherein Z is a polar monomer or mixture of polar monomers. Polar groups, e.g., polyoxyalkylenes, acrylates including hydroxyethylacrylate, acrylamides including methacrylamide-will typically increase adhesion to most substrates. If the polar species “Z” is acrylic acid, it is preferred that it comprise about 1-10 wt. percent of the polymer.

The backbone of the polymer (defined by “M”) may be any organic structure (aliphatic or aromatic hydrocarbon, ester, ether, amide, etc.) or an inorganic structure (sulfide, phosphazine, silicone, etc.), and may include spacer linkages which can be any suitable organic or inorganic unit, for example ester, amide, hydrocar bon, phenyl, ether, or ionic salt (e.g., a carboxyl-alkyl ammonium or sulphonium or phosphonium ion pair or other known ionic salt pair).

The side-chain (defined by ‘S’ and ‘C’) may be aliphatic or aromatic or a combination of aliphatic and aromatic, but must be capable of entering into a crystal line state. Common examples are: linear aliphatic side chains of at least 10 carbon atoms, e.g., C₄-C₂₂ acryl ates or methacrylates, acrylamides or methacrylanides, vinyl ethers or esters, siloxanes or alpha olefins; fluorinated aliphatic side-chains of at least 6 carbons; and p-alkyl styrene side-chains wherein the alkyl is of 8 to 24 carbon atons.

The length of the side-chain moiety is usually greater than 5 times the distance between side-chains in the case of acrylates, methacrylates, vinyl esters, acrylamides, methacrylamides, vinyl ethers and alpha olefins. In the extreme case of a fluoroacrylate alternate copolymer with butadiene, the side-chain can be as little as two times the length as the distance between the branches.

In any case, the side-chain units should make up greater than 50 percent of the volume of the polymer, preferably greater than 65 percent of the volume. Specific examples of side-chain crystallizable monomers are the acrylate, fluoroacrylate, methacrylate and vinyl ester polymers described in J. Poly. Sci 10:3347 (1972); J. Poly. Sci 10:1657 (1972); J. Poly. Sci 9:3367 (1971); J. Poly. Sci 9:3349 (1971); J. Poly. Sci. 9:1835 (1971); J.A.C.S. 76:6280 (1954); J. Poly, Sci 7:3053 (1969); Polymer J. 17:991 (1985), corresponding acryl amides, substituted acrylamide and maleimide polymers (J. Poly. Sci: Poly. Physics Ed. 18:2197 (1980); polyal phaolefin polymers such as those described in J. Poly. 5,156,911 7 Sci. Macromol. Rey, 8:117-253 (1974) and Macromolecules 13:12 (1980), polyalkylvinylethers, polyalkylethylene oxides such as those described in Macromolecules 13:15 (1980), alkylphosphazene polymers, polyamino acids such as those described in Poly. Sci. USSR 21:241, Macromolecules 18:2141, polyisocyanates such as those described in Macromolecules 12:94 (1979), polyurethanes made by reacting amine-or alcohol-containing monomers with long-chain alkyl isocyanates, polyesters and polyethers, polysiloxanes and polysilanes such as those described in Macromolecules 19:611 (1986), and p-alkylstyrene polymers such as those described in J.A.C.S. 75:3326 (1953) and J. Poly. Sci 60:19 (1962). Of specific utility are polymers which are both relatively polar and capable of crystallization, but wherein the crystallizing portion is not affected by moisture. For example, incorporation of polyoxyethylene, polyoxy propylene, polyoxybutylene or copolyoxyalkylene units in the polymer will make the polymer more polar.

In a particularly preferred embodiment herein, in the above structure, —C is selected from the group consisting of -(CH₂)-CH₃ and -(CF₂)ₙ-CF₂H, where n is an integer in the range of 8 to 20 inclusive, —S— is selected from the group consisting of —O—, —CH₂—, -(CO)-, —O(CO)- and —NR— where R is hydrogen or lower alkyl (1-6° C.), and —M— is -[(CH₂)ₘCH]- where m is 0 to 2.

Typical “Y” units include linear or branched alkyl or aryl acrylates or methacrylates, alpha olefins, linear or branched alkyl vinyl ether or vinyl esters, maleicesters or itaconic acid esters, acrylamides, styrenes or substituted styrenes, acrylic acid, methacrylic acid and hy drophilic monomers as detailed in WO84/0387, cited supra.

Some useful side-chain crystallizable polymers, and monomers for preparing side-chain crystallizable polymers, are also available from commercial suppliers, for example, Scientific Polymer Products, Inc., Ontario, N.Y., Sigma-Aldrich, Saint Louis, Mo., TCI America, Portland Oreg., Monomer-Polymer & Dajac Labs, Inc., Trevose, Pa., San Esters Corp., New York, N.Y., Sartomer USA, LLC, Exton Pa., and Polysciences, Inc. Other materials may be SCCs alone, without SCCs, or alkane waxes blended without SCCs.

According to some embodiments, the carrier material 200 is electrically nonconductive, insulative, resistive, or otherwise resists or substantially prevents the conduction of electricity through the carrier material 200. The conductive particles 210 are suspended in the carrier material 200, out of contact with one another, and substantially prevented from movement by a solid matrix of the carrier material 200 and thus prevented from forming an electrical connection across the environmental indicator material 130.

According to some embodiments, the conductive particles 210 may include particles of conductive metals, such as copper, silver, gold, aluminum, zinc, tin, similar metals, and alloys thereof. The conductive particles 210 may also include particles of graphene, graphite, graphene oxides, and other functionalized graphenes, and particles containing conductive non-metals. It will be appreciated that the conductive particles 210 may be formed in whole or in part by any electrically conductive substance or material operable to be particlized.

The present disclosure further contemplates embodiments in which the carrier material 200 may be electrically conductive and facilitates the conduction of electricity through the carrier material 200. In some examples, the carrier material 200 may be electrically nonconductive when in one of the liquid phase and the solid phase, and is electrically conductive when in the other of the liquid phase and the solid phase. In some examples the carrier material may have a first electrical conductivity when in one of the solid phase, the liquid phase, and a first viscous state, and has a second electrical conductivity in another of the solid phase, the liquid phase, and a second viscous state.

According to some embodiments, a second example environmental indicator material 130 is a substance having a sensitivity to a particular type of electromagnetic radiation (e.g., particular frequency, wavelength, intensity, and the like), which exhibits a change in conductivity, responsive to an exposure to the particular type of electromagnetic radiation. As a non-limiting example, the environmental indicator material 130 may include an ultraviolet (UV) curable conductive epoxy, where prior to an exposure to UV radiation, the environmental indicator material 130 has is in a nonconductive state, and responsive to an exposure to UV radiation, the environmental indicator material 130′ cures, transitioning to a conductive state. Certain conductive polymer gels and Hydrogels are known to exhibit light catalyzed variable conductivity via cross-linking. Examples include Poly(N-alkylacrylamides) and polyacrylamide, Polyaniline, Polypyrrole, Polyimide, combinations thereof and the like.

According to some embodiments, a third example environmental indicator material 130 is a hydratable compound, which changes conductivity responsive to contact with water, (e.g. as the compound is hydrated). As a non-limiting example, the environmental indicator material 130 may include a hydrated compound which, when hydrated to a predetermined threshold (e.g., by exposure to humidity, water vapor, or liquid water), has a conductivity sufficient to transition the material 103′ to the conductive state. Furthermore, some soluble polymers are hydroscopic and when coated as a film over a substrate, the coating acts as a sponge and absorbs moisture, subsequently impacting the conductivity. The replacement of air in the coating (e.g., filling pores of the sponge) with moisture will trigger a change in conductivity. Examples of water-soluble polymers include: PVA, PVP, PEG, Acrylics, water reducible epoxy, Cellulose, Water soluble Gum, combinations thereof, and the like.

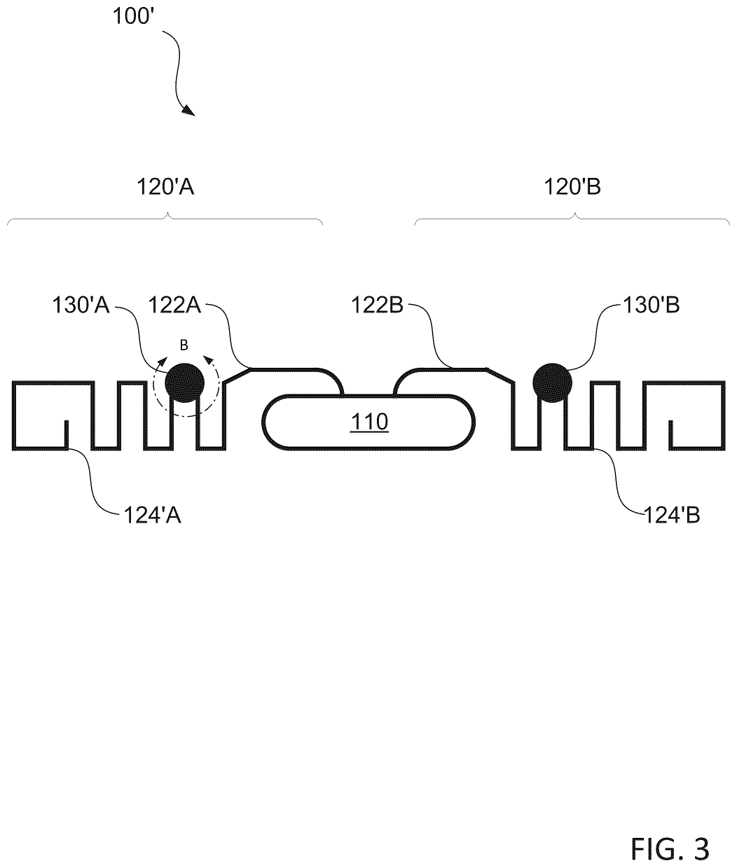

FIG. 3 illustrates the extended antenna state of the RFID tag 100′, according to embodiments of the present disclosure. Responsive to a predetermined environmental exposure, the environmental indicator material 130 transitions from the nonconductive state to the conductive state. When the environmental indicator material 130′ is in the conductive state, the integrated circuit 110 is electrically connected to the first antenna portion 122 and the second antenna portion 124′ (e.g., the second antenna portion 124′ is in the closed circuit with the first antenna portion 122 and the integrated circuit 110). The functional length of the antenna 120 is the total length of the antenna portions in a closed circuit with the integrated circuit. Thus, when the second antenna portion 124′ is in the closed circuit with the first antenna portion 122 and the integrated circuit 110, the functional length of the antenna 120 is approximately the sum of the length of the first antenna portion 122 and the length of the second antenna portion 124′, and the RFID tag 100′ is considered to be in the extended antenna state.

Said differently, when the environmental indicator material 130′ is in the conductive state, the environmental indicator material 130′ facilitates an electrical connection between the first antenna portion 122 and the second antenna portion 124′. When in the conductive state, the environmental indicator material 130′ may act as a wire and facilitate an electrical connection between two or more elements connected by the environmental indicator material 130′.

When the RFID tag 100′ is interrogated by an interrogating device having a specified frequency and power range, the RFID tag 100 engages in a predetermined extended antenna response behavior, corresponding to the extended antenna state, and distinct from the predetermined restricted antenna response behavior. In some examples, the predetermined extended antenna response behavior is to output a response signal, having a predetermined frequency, read range, and/or data content. In some examples, the predetermined extended antenna response behavior is a non-response.

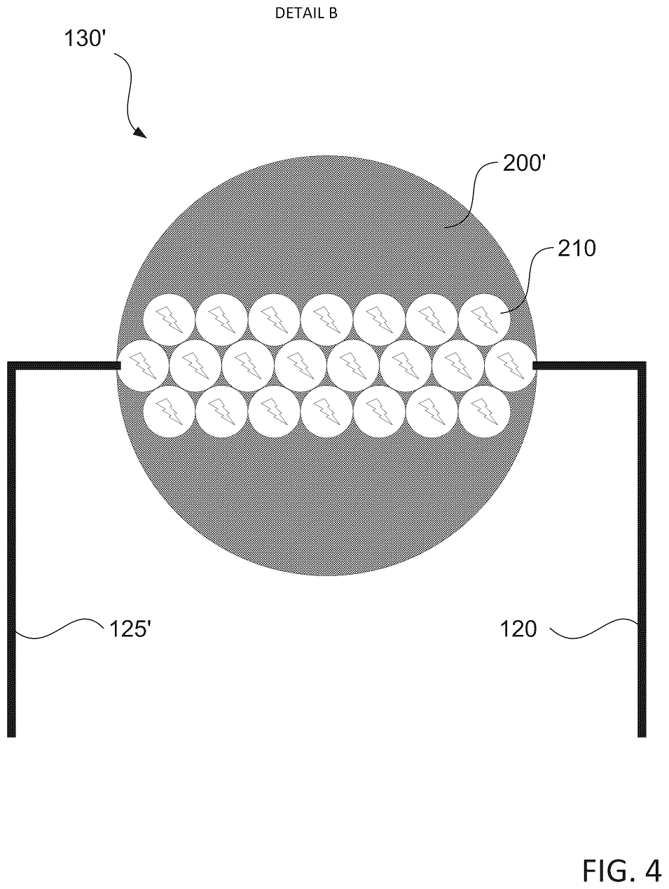

FIG. 4 illustrates Detail B of FIG. 3 in which the environmental indicator material 130′ in the conductive state is depicted, according to embodiments of the present disclosure. Following an exposure to the predetermined stimulus, the environmental indicator material 130 transitions from the nonconductive state to the conductive state.

In the illustrated embodiment, the first example carrier material 200′ liquefies in response to the predetermined environmental exposure, releasing the conductive particles 210 from the solid matrix (e.g. the solid matrix is disengaged), such that the conductive particles 210 are no longer substantially prevented from movement through the environmental indicator material 130′. When the carrier material 200′ is liquefied, the conductive particles 210 may form an electrical connection between the first antenna portion 122 and the second antenna portion 124′, such that the second antenna portion 124′ is electrically connected to the integrated circuit and the first antenna portion. The conductive particles 210 may form the electrical connection by migrating through the liquefied carrier material 200′, motivated by electromagnetic forces or fields originating from the antenna 120, to form a wire or functionally similar arrangement capable of providing an electrical connection between the first antenna portion and the second antenna portion. In some embodiments, the force of gravity, or other force may be relied upon to motivate the conductive particles to migrate through the carrier material 200′ to form the electrical connection.

In some examples, the transition from the nonconductive state to the conductive state is a permanent change, such that once the environmental indicator material 130 has transitioned to the conductive state, the RFID tag 100′ remains in the extended antenna state permanently.

In some examples, the transition from the nonconductive state to the conductive state is reversible or irreversible, where a conclusion of the exposure to the predetermined environmental stimulus or an exposure of the environmental indicator material 130′ to a specified stimulus (e.g. distinct from the predetermined environmental stimulus) is sufficient to subsequently revert the material to the nonconductive state, such that the RFID tag 100 is in the restricted antenna state.

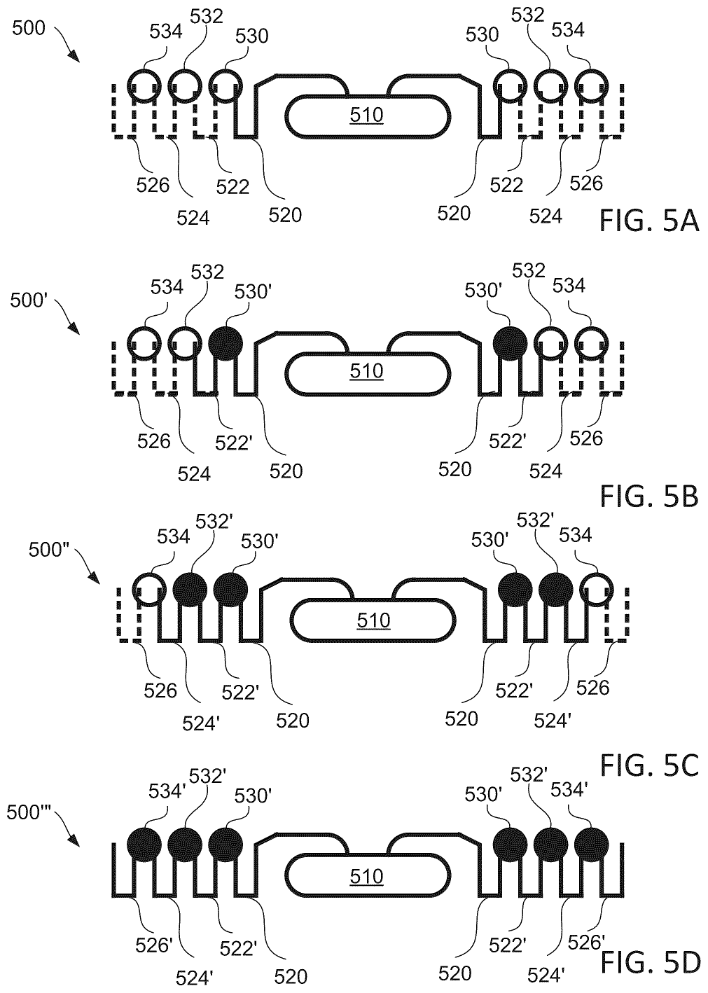

FIGS. 5A-5D illustrate various conductive states of an RFID tag 500 with progressive environmental read range, according to embodiments of the present disclosure. The RFID tag 500 includes a first antenna portion 520 electrically connected to an integrated circuit 510, a second antenna portion 522, a third antenna portion 524, a fourth antenna portion 526, a first material 530, a second material 532, a third material 534, and a fourth material 536. The first antenna portion 520 is physically joined to the second antenna portion 522 by the first material 530. The second antenna portion 522 is physically joined to the third antenna portion 524 by the second material 532. The third antenna portion 524 is physically joined to the fourth antenna portion 526 by the third material 534. The first material, the second material, and the third material may be referred to generally or collectively as the materials 530.

According to some embodiments, each of the materials 530 having a conductivity dependent on environmental conditions, such that each of the materials 530 has a conductive state and a nonconductive state and may transition from the nonconductive state to the conductive state, or vice versa, responsive to a predetermined environmental exposure. In some examples, each material 530 may be a variation on, or one of the example environmental indicator materials 130 described in reference to FIGS. 1-4.

According to some embodiments, each of the materials 530 may be configured to transition from the nonconductive state to the conductive state responsive to different thresholds of predetermined environmental stimuli of a common type. As an example, the first material 530 may be configured to transition from the conductive state to the nonconductive state responsive to a temperature exposure above a first predetermined threshold, and the second material 532 may be configured to make the same transition responsive to a temperature exposure above a second predetermined threshold. The third material 534 may transition responsive to a temperature exposure above a third predetermined threshold.

According to some embodiments, the materials 530 may be configured to respond to predetermined environmental stimuli of different types. The material 530 may be configured to transition between the nonconductive state and the conductive state responsive to a temperature excursion above a predetermined temperature, a temperature excursion above a predetermined temperature threshold for at least a predetermined amount of time, a temperature excursion below a predetermined temperature, a temperature excursion below a predetermined temperature for at least a predetermined amount of time, cumulative exposure to temperature over a time period above a predetermined threshold for at least a predetermined amount of time, an exposure to a particular chemical, an oxygen exposure, an ammonia exposure, an exposure to a particular chemical above a threshold concentration, an exposure to a particular chemical above the threshold concentration for at least a predetermined amount of time, an exposure to at least a predetermined amount of radiation of a particular type, an predetermined electromagnetic exposure, a humidity exposure, an exposure to a humidity level above a predetermined threshold, an exposure to a humidity level above a predetermined threshold for at least a predetermined amount of time, and the like.

FIG. 5A illustrates the RFID tag 500 in a first state, in which each of the materials 530 is in the nonconductive state, according to embodiments of the present disclosure. The integrated circuit is electrically connected to the first antenna portion 520. The second antenna portion 522, third antenna portion 524, and fourth antenna portion 526 are not electrically connected to the first antenna portion 520 nor the integrated circuit 510. In the first state, the functional antenna length of the RFID tag 500 is the length of the first antenna portion 520. When the RFID tag 500 is interrogated by an interrogating device having a specified frequency and power range, the RFID tag 500 engages in a first predetermined response behavior, corresponding to the first state. In some examples, the first predetermined response behavior is a first response signal, having a first predetermined frequency, read range, and/or data content. In some examples, the first predetermined response behavior is a non-response.

FIG. 5B illustrates the RFID tag 500′ in a second state, in which the first material 530′ is in the conductive state, the second material 532 is in the nonconductive state and the third material 534 is in the nonconductive state, according to embodiments of the present disclosure. Responsive to a first predetermined threshold of an environmental stimulus, or a first distinct environmental stimulus, the first material 530′ transitions to the conductive state and facilitates an electrical connection between the first antenna portion 520 and the second antenna portion 522′, such that the second antenna portion 522′ is electrically connected to the integrated circuit 510 and the first antenna portion 520. In the second state, the functional antenna length of the RFID tag 500′ is the sum of the length of the first antenna portion 520 and the length of the second antenna portion 522′. When the RFID tag 500′ is interrogated by an interrogating device having a specified frequency and power range, the RFID tag 500′ engages in a second predetermined response behavior, corresponding to the second state and distinct from the first response behavior. In some examples, the second predetermined response behavior is to output a second response signal, having a second predetermined frequency, read range, and/or data content. In some examples, the second predetermined response behavior is a non-response.

FIG. 5C illustrates the RFID tag 500″ in a third state, in which the first material 530′ is in the conductive state, the second material 532′ is in the conductive state and the third material 534 is in the nonconductive state, according to embodiments of the present disclosure. The third state of the RFID tag 500″ may only occur once the second state has been reached. Responsive to a second predetermined threshold of an environmental stimulus, or a second distinct environmental stimulus, the second material 532′ transitions to the conductive state and facilitates an electrical connection between the second antenna portion 522′ and the third antenna portion 524′, such that the third antenna portion 524′ is electrically connected to the integrated circuit 510, the first antenna portion 520′, and the second antenna portion 522′. In the third state, the functional antenna length of the RFID tag 500″ is the sum of the length of the first antenna portion 520′, the length of the second antenna portion 522′, and the length of the third antenna portion 524′. When the RFID tag 500″ is interrogated by an interrogating device having a specified frequency and power range, the RFID tag 500″ engages in a third predetermined response behavior, corresponding to the third state and distinct from the first response behavior and the second response behavior. In some examples, the third predetermined response behavior is to output a third response signal, having a third predetermined frequency, read range, and/or data content. In some examples, the third predetermined response behavior is a non-response.

FIG. 5D illustrates the RFID tag 500″′ in a fourth state, in which the first material 530′ is in the conductive state, the second material 532′ is in the conductive state and the third material 534′ is in the conductive state, according to embodiments of the present disclosure. The fourth state of the RFID tag 500″ may only occur once the third state has been reached. Responsive to a third predetermined threshold of an environmental stimulus, or a third distinct environmental stimulus, the third material 534′ transitions to the conductive state and facilitates an electrical connection between the third antenna portion 524′ and the fourth antenna portion 526′, such that the fourth antenna portion 526′ is electrically connected to the integrated circuit 510, the first antenna portion 520′, the second antenna portion 522′, and the third antenna portion 524′. In the fourth state, the functional antenna length of the RFID tag 500″′ is the sum of the length of the first antenna portion 520′, the length of the second antenna portion 522′, the length of the third antenna portion 524′ and the length of the fourth antenna portion 526′. When the RFID tag 500′″ is interrogated by an interrogating device having a specified frequency and power range, the RFID tag 500″′ engages in a fourth predetermined response behavior, corresponding to the fourth state and distinct from the first response behavior, the second response behavior and the third response behavior. In some examples, the fourth predetermined response behavior is to output a fourth response signal, having a fourth predetermined frequency, read range, and/or data content. In some examples, the fourth predetermined response behavior is a non-response.

According to some embodiments, the fourth response signal has a greater range than the third response signal, and the third response signal has a greater read range than the second response signal, and the second response signal has a greater read range than the first response signal.

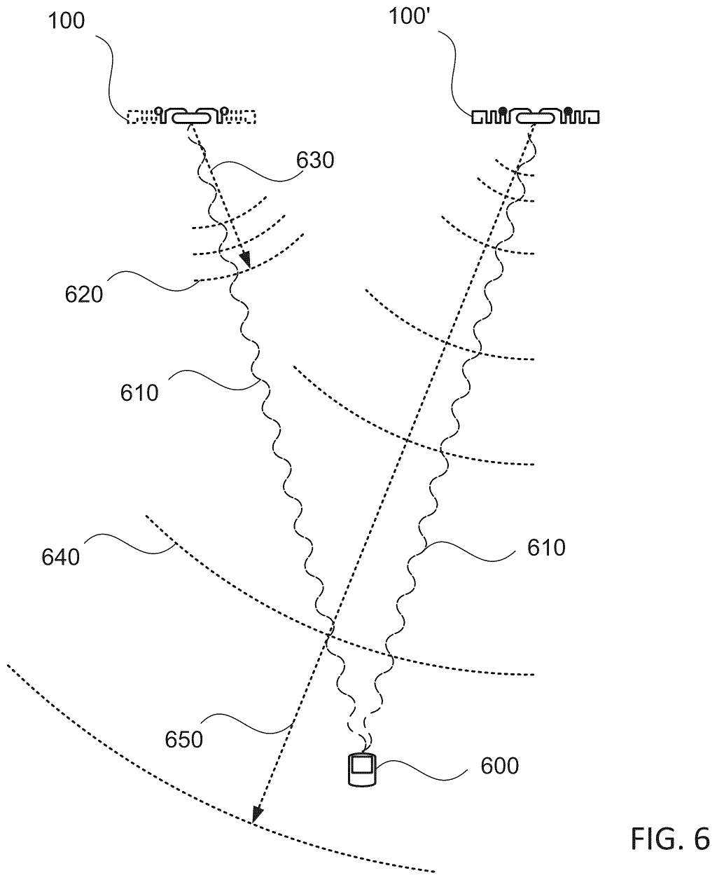

FIG. 6 illustrates an RFID reader 600 and RFID tags 100, according to embodiments of the present disclosure. As illustrated in FIG. 6, a first RFID tag 100 is in the restricted antenna state, where the environmental indicator material 130 is in the nonconductive state (see FIGS. 1-2), and a second RFID tag 100′ is in the extended antenna state, where the environmental indicator material 130′ is in the conductive state (see FIGS. 3-4). The RFID tags 100, 100′ are interrogated by the RFID reader 600 (e.g. interrogation device), emitting an interrogation signal 610 at a specified frequency, power range and duration.

When the antenna 120 of the RFID tag 100 in the restricted antenna state receives the interrogation signal 610, the RFID tag 100 in the restricted antenna state engages in the predetermined restricted antenna response behavior. As illustrated, the predetermined restricted antenna response behavior is a restricted antenna RF response 620 having a first read range 630. Note that in various embodiments, the predetermined restricted antenna response behavior may be a non-response because the RFID reader 600 is disposed away from the RFID tag 100 at a distance that is greater than the read range of the RFID tag 100 in the restricted antenna state for the interrogation signal output by the RFID reader 600 with the specified frequency, power, and duration. In some examples, the RFID tag 100 in the restricted antenna state may be unable to harvest sufficient amount of energy from the interrogation signal to power the logic circuit of the RFID tag 100. If the RFID reader was closer to the RFID tag 100, i.e., within the read range 630 of the RFID tag 100 for the specified frequency, power, and duration of the interrogation signal, the RFID reader 600 would receive the response from the RFID tag 100.

When the antenna 120′ of the RFID tag 100′ in the extended antenna state receives the interrogation signal 610, the RFID tag 100′ in the extended antenna state engages in the predetermined extended antenna response behavior. As illustrated, the predetermined extended antenna response behavior is an extended antenna RF response 640 having a second read range 650. In the extended antenna state, the first antenna portion 122 and the second antenna portion 124′ are in a closed circuit with the integrated circuit, and the functional antenna length is the entire length of the antenna 120, resulting in an increased read range relative to the read range of restricted antenna state.

In some examples, the read range 630 of an RFID tag 100 in the restricted antenna state may have a radius of about 1 millimeter, 1 centimeter (cm), 10 cm, 1 meter (m), 5 m, 10 m, or about 25 m.

In some examples, the read range 650 of an RFID tag 100′ in the extended antenna state may have a radius of about 10 cm, 1 meter (m), 5 m, 10 m, 25 m, 50 m or about 100 m.

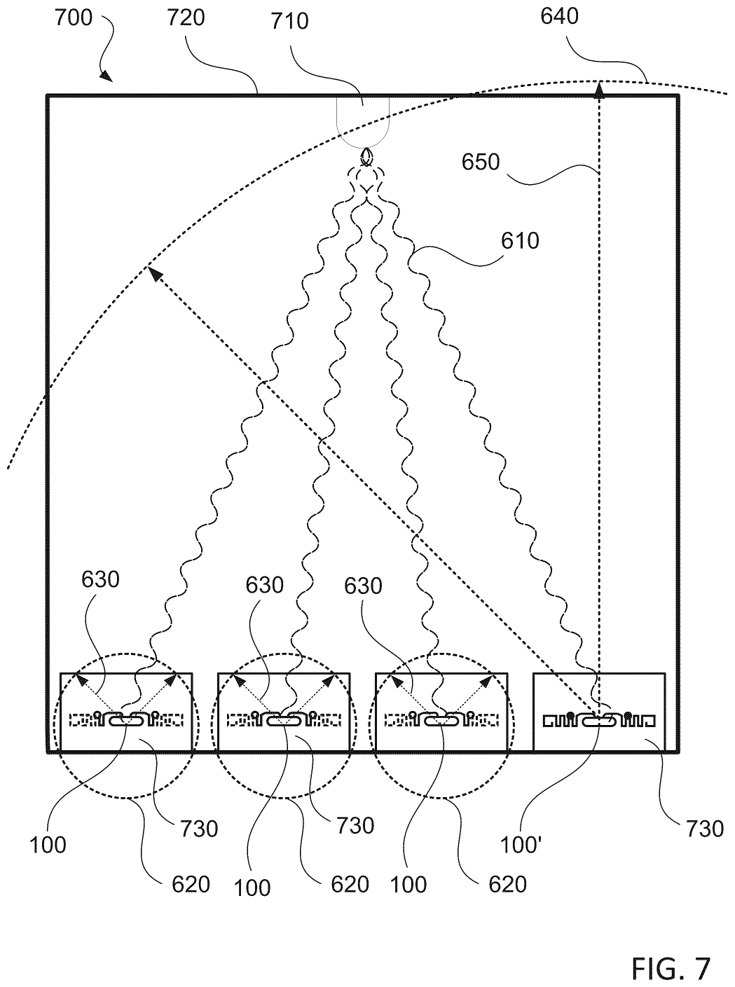

FIG. 7 illustrates an example system 700 implementing a fixed RFID reader 710 in a defined space 720, and a plurality of RFID tags 100. In the example system 700, each of the RFID tags 100 is associated with, or otherwise attached to, a respective host product 730, where each of the host products 730 has an environmental sensitivity corresponding to the predetermined environmental stimulus that the environmental indicator material 130 in the RFID tags 100 is configured to respond to. The defined space 720 may be a warehouse, a room, a refrigerator, a transport container, a defined portion of a conveyor belt, or similar defined space where environmentally sensitive items may be disposed. Each of the RFID tags 100 emit a restricted antenna RF response 620 when the RFID tags 100 are in the restricted antenna state and emit a extended antenna RF response 640 when the RFID tags are in the extended antenna state. The extended antenna RF response 640 may have a read range 650 greater than a read range 630 of the restricted antenna RF response 620.

The RFID reader 710 may be fixed in place and disposed at proximately to the host products 730 and RFID tags 100, such that the RFID reader 710 is beyond the read range 630 of the restricted antenna RF response 620, but within the read range 650 of the extended antenna RF response 640. Thus, when a given host product 730 is exposed to the predetermined environmental stimulus, so too is the RFID tag 100 associated with the given host product 730 exposed to the predetermined environmental stimulus, resulting in the RFID tag 100 transitioning from the restricted antenna state (e.g. where the restricted antenna RF response 620 is not detected by the RFID reader 710) to the extended antenna state (e.g., where the extended antenna RF response 640 can be detected by the RFID reader 710), indicating that the given host product has been exposed to the predetermined environmental stimulus. Stated differently, the RFID reader 710 may continuously or intermittently emit interrogation signals 610, but only receive extended antenna RF responses 640, as the read range 630 of restricted antenna RF responses 620 are insufficient to reach or respond to the RFID reader 710. Thus, the RFID reader 710 is not inundated with restricted antenna RF responses 620 from several restricted antenna RFID tags 100, but only extended antenna RF responses 640 from extended antenna RFID tags 100′, indicating a potentially compromised host product 730.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A radiofrequency identification (RFID) tag, comprising:
an integrated circuit;
an environmental indicator material that changes between a conductive state and a nonconductive state responsive to a predetermined environmental exposure; and
an antenna, having a first antenna portion and a second antenna portion;
wherein the first antenna portion is electrically connected in a closed circuit with the integrated circuit, and
wherein the second antenna portion is electrically connected in the closed circuit with the first antenna portion and with the integrated circuit when the environmental indicator material is in the conductive state and in an open circuit when the environmental indicator material is in the nonconductive state.

2. The RFID tag of claim 1, wherein the RFID tag has a first read range in response to an interrogation signal from an RFID reader having a specified frequency range and a specified power range when the environmental indicator material is in the nonconductive state and a second read range in response to the interrogation signal from the RFID reader having the specified frequency range and the specified power range when the environmental indicator material is in the conductive state, the second read range being greater than the first read range.

3. The RFID tag of claim 2, wherein the RFID tag is unresponsive to the interrogation signal from the RFID reader when the RFID reader is spaced away from the RFID tag by a distance that is greater than the first read range and less than the second read range and the environmental indicator material is in the nonconductive state and is responsive to the interrogation signal from the RFID reader to output a response signal when the RFID reader is spaced away from the RFID tag by a distance that is greater than the first read range and less than the second read range and the environmental indicator material is in the conductive state.

4. The RFID tag of claim 2, wherein when the RFID tag is unresponsive to the interrogation signal, a lack of the response signal is indicative that the predetermined environmental exposure has not occurred and when the RFID tag is responsive to output the response signal to the interrogation signal from the RFID reader, the output of the response signal is indicative of an occurrence of the predetermined environmental exposure.

5. The RFID tag of claim 1, wherein the integrated circuit is configured, responsive to the RFID tag being interrogated by an interrogation signal in a predetermined radiofrequency range which is received by the antenna, to cause the antenna to emit a first distinct radiofrequency response when the second antenna portion is in the closed circuit, and a second distinct radiofrequency response when the second antenna portion is in the open circuit.

6. The RFID tag of claim 5, wherein a distance at which the first distinct radiofrequency response can be detected by an interrogating device is greater than a distance at which the second distinct radiofrequency response can be detected by the interrogating device.

7. The RFID tag of claim 6, wherein the first distinct radiofrequency response and second distinct radiofrequency response are emitted on different frequencies.

8. The RFID tag of claim 5, wherein the integrated circuit comprises a memory storing a data, and the first distinct radiofrequency response and the second distinct radiofrequency response transmit the data.

9. The RFID tag of claim 1, wherein the environmental indicator material is connectively disposed between the first antenna portion and the second antenna portion, such that a length of the antenna that is connected in a closed circuit with the integrated circuit corresponds to whether the environmental indicator material is conductive state or nonconductive state.

10. The RFID tag of claim 1, wherein the environmental indicator material transitions from the nonconductive state to the conductive state responsive to the predetermined environmental exposure.

11. The RFID tag of claim 1, wherein the environmental indicator material transitions from the conductive state to the nonconductive state responsive to the predetermined environmental exposure.

12. The RFID tag of claim 7, wherein the environmental indicator material reverts to the nonconductive state responsive to a conclusion of the predetermined environmental exposure.

13. The RFID tag of claim 7, wherein the environmental indicator material remains in the conductive state permanently, when no longer exposed to the predetermined environmental exposure.

14. The RFID tag of claim 2, wherein the RFID tag is a passive RFID tag, and the interrogation signal received by the antenna powers the integrated circuit to cause the antenna to emit a radiofrequency response.

15. The RFID tag of claim 1, further comprising a battery, wherein the integrated circuit is electrically connected to the battery and powered by the battery.

16. The RFID tag of claim 1, wherein the predetermined environmental exposure is selected from a group consisting of: a temperature excursion above a predetermined temperature, a temperature excursion above a predetermined temperature threshold for at least a predetermined amount of time, a temperature excursion below a predetermined temperature, a temperature excursion below a predetermined temperature for at least a predetermined amount of time, cumulative exposure to temperature over a time period above a predetermined threshold for at least a predetermined amount of time, an exposure to a particular chemical, an oxygen exposure, an amount of time, an exposure to at least a predetermined amount of radiation of a particular type, an predetermined electromagnetic exposure, a humidity exposure, an exposure to a humidity level above a predetermined threshold, and an exposure to a humidity level above a predetermined threshold for at least a predetermined amount of time.

17. The RFID tag of claim 1, wherein the environmental indicator material includes conductive particles suspended in a solid matrix, wherein the predetermined environmental exposure disengages the solid matrix such that the conductive particles contact one another and transition the environmental indicator material to the conductive state.

18. The RFID tag of claim 17, wherein the matrix comprises a material selected from a group consisting of: a polymer having side-chain crystallinity, an alkane, a wax, an alkane wax, and combinations thereof.

19. The RFID tag of claim 1, wherein the predetermined environmental exposure is an exposure to electromagnetic radiation above a predetermined threshold, and the environmental indicator material includes a substance that cures responsive to the electromagnetic radiation, and is electrically conductive when cured, such that when exposed to the electromagnetic radiation above the predetermined threshold, the substance cures and transitions to the conductive state.

20. The RFID tag of claim 1, wherein the predetermined environmental exposure is an exposure to a predetermined humidity level, and the environmental indicator material includes a hydratable substance that is electrically conductive when hydrated, such that an exposure to the predetermined humidity level is sufficient to hydrate the hydratable substance and transition the environmental indicator material to the conductive state.

21. A radiofrequency identification (RFID) tag, comprising:
an integrated circuit;
a plurality of environmental indicator materials that each change between a conductive state and a nonconductive state responsive to respective predetermined environmental exposures; and
an antenna having a plurality of antenna portions;
wherein a first antenna portion of the plurality of antenna portions is electrically connected in a closed circuit with the integrated circuit;
wherein a second antenna portion of the plurality of antenna portions is electrically connected in a closed circuit with the first antenna portion and the integrated circuit when a first of the environmental indicator materials is in the conductive state, and in an open circuit with the integrated circuit and the first antenna portion when the first of the environmental indicator materials is in the nonconductive state, and
wherein a third antenna portion of the plurality of antenna portions is electrically connected in a closed circuit with the second antenna portion, the first antenna portion, and the integrated circuit when a second of the environmental indicator materials and the first of the environmental indicator materials are both in the conductive state, and in the open circuit with the integrated circuit and the first antenna portion when at least one of the first of the environmental indicator materials and the second of the environmental indicator materials is in the nonconductive state.

22. The RFID tag of claim 21, wherein the RFID tag has a first read range in response to an interrogation signal from an RFID reader having a specified frequency range and a specified power range when the first of the environmental indicator materials is in the nonconductive state and a second read range in response to the interrogation signal from the RFID reader having the specified frequency range and the specified power range when the first of the environmental indicator materials is in the conductive state, the second read range being greater than the first read range.

23. (canceled)

24. The RFID tag of claim 22, wherein the RFID tag is unresponsive to the interrogation signal from the RFID reader when the RFID reader is spaced away from the RFID tag by a distance that is greater than the first read range and less than the second read range and the first of the environmental indicator materials is in the nonconductive state and is responsive to the interrogation signal from the RFID reader to output a response signal when the RFID reader is spaced away from the RFID tag by a distance that is greater than the first read range and less than the second read range and the first of the environmental indicator materials is in the conductive state.

25-44. (canceled)

45. A system, comprising:
an interrogation device, configured to emit an interrogation signal in a predetermined radiofrequency range;
a host product, having an environmental sensitivity; and
an RFID tag, disposed proximately to the host product, including:
an integrated circuit;
an environmental indicator material that changes between a conductive state and a nonconductive state responsive to a predetermined environmental exposure; and
an antenna, having a first antenna portion and a second antenna portion;
wherein the first antenna portion is electrically connected in a closed circuit with the integrated circuit,
wherein the second antenna portion is electrically connected in the closed circuit with the first antenna portion and with the integrated circuit when the environmental indicator material is in the conductive state and in an open circuit when the environmental indicator material is in the nonconductive state,
wherein a response behavior of the RFID tag responsive to the interrogation signal of the interrogation device, which is received by the antenna, changes corresponding to whether the environmental indicator material is in the conductive state or the nonconductive state to indicate whether the host product has been exposed to the predetermined exposure corresponding to the environmental sensitivity of the host product.

46-47. (canceled)

48. The system of claim 46, wherein the first distinct radiofrequency response is detectable within a first range by the interrogation device, and the second distinct radiofrequency response is detectable within a second range by the interrogation device, the second range being larger than the first range.

49-50. (canceled)

51. The system of claim 48, further comprising a plurality of host products, each having a respective RFID tag, wherein the interrogation device is disposed beyond the first range of each RFID tag and within the second range of each RFID tag, such that when a given host product is exposed to the predetermined environmental exposure, the environmental indicator material of the respective RFID tag transitions to the conductive state and the respective RFID tag has the second distinct radiofrequency response having the second range, and the respective RFID tag is detectable by the interrogation device.

52. (canceled)
